(19) United States
(12) Patent Application Publication
(10) Pub. No.: US 2013/0219014 A1
(43) Pub. Date: Aug. 22, 2013

(54) METHOD AND SYSTEM FOR PROVIDING CUSTOMIZED INFORMATION OVER A NETWORK

(71) Applicant: Gface GmbH, (US)

(72) Inventor: Cevat Yerli, Frankfurt/Main (DE)

(73) Assignee: GFACE GMBH, Frankfurt/Main (DE)

(21) Appl. No.: 13/766,713

(22) Filed: Feb. 13, 2013

Related U.S. Application Data
(60) Provisional application No. 61/599,919, filed on Feb. 16, 2012.

(51) Int. Cl. H04L 29/08

(52) U.S. Cl. CPC H04L 67/02
USPC 709/217

(57) ABSTRACT

A user of a network system may be provided with customized information relating to geographical zones defined by said user and personal interests associated with these zones. The personal interests may be compared against selected criteria provided by a customized information provider, to allow efficient targeting.

### CROSS-REFERENCE TO RELATED APPLICATION

This application claims the benefit of U.S. Provisional Patent Application No. 61/599,919, filed Feb. 16, 2012, the disclosure of which is incorporated by reference herein in its entirety.

### FIELD

The present disclosure relates to methods and systems for providing customized information to a user in a network, and in particular, customized information associated with geographical areas such as zones or maps.

### BACKGROUND

The advent of the Internet has provided a great impetus to social networking by allowing instant and efficient communication among friends and acquaintances. There is now a trend for people to gather in a variety of virtual social networks to share communal related interests. For instance, such networks may be directed at people sharing a common profession, people living in the same city, or people playing a network computer game.

Concurrent with the trend towards social networking, mobile computing is becoming more widespread and important, in particular among users of social networks. Hence, there remains a need to provide users of a network with customized information in accordance with the geographical areas frequented by the users, and in accordance with their interests.

### SUMMARY

This need is addressed by a method and system for providing customized information according to the present disclosure.

The present disclosure relates to methods and systems for providing customized information to a user in a network, particularly customized information associated with geographical areas such as zones or maps defined or selected by a user.

Various embodiments described herein can be implemented by a server that provides network services (e.g., social network services). Various embodiments described herein also can be implemented by a customized information provider employing a network to provide customized information to users.

A method for providing customized information to a user in a network according to the present disclosure comprises the steps of associating interest data with data relating to a geographical zone, said geographical zone and/or said interest data defined or selected by said user; associating customized information with said interest data and/or said geographical zone; and providing said customized information to said user.

According to at least one embodiment of the present disclosure, the user is allowed to define and/or select a geographical zone that is relevant to the user, and to define and/or select interest data related to said geographical zone. This information may be provided to a server and may allow the server and/or third parties to provide customized information to the user in accordance with said interest data and/or said geographical zone. For instance, if a user designated an interest in shopping, the user may be informed about promotional sales taking place within the geographical zone. Alternatively, if the user is interested in food or restaurants, said customized information may be information relating to openings of new restaurants in said geographical zone or special offers at existing restaurants in said geographical zone.

In general, a geographical zone may be any geographical zone or region. Said zone may be in the real world or in a virtual world, such as in a setting of a network computer game. For instance, a geographical zone may be the vicinity of the user's home or workplace, or any other region that the user visits frequently. Alternatively, the geographical zone may be any zone or region in the setting of a computer game that the user plays regularly, either alone or with friends over a network.

Said interest data may comprise any kind of data or information relating to an interest of said user or a group of users, such as an interest in food or restaurants, fashion, or sports. Said interest may also be a common interest of members of a social network group.

The step of associating said interest data with said geographical zone may be any step of linking or relating said interest data to said geographical zone. This may also incorporate the storing of said interest data together with data relating to said geographical zone, or the processing of said interest data together with data relating to said geographical zone. Said association may be provided to a network server by said user.

In a representative embodiment, the method comprises the steps of associating said geographical zone and/or said interest data with temporal user data, and associating said customized information with said temporal user data. Said temporal user data may be defined or selected by said user.

Said temporal user data may be any time information relating to said geographical zone and/or to said interests. For instance, temporal data may comprise a repeated occurrence, such as every day, only on Sundays, only from December to March, or one time only. The temporal data may designate the times at which a user is interested in receiving customized information relating to said geographical zone. For instance, if the geographical zone is in the vicinity of the user's workplace and the interest data relates to food, the user may choose to receive customized information only around lunchtime. Associating the customized information with said temporal user data may, therefore, allow more accurate and more efficient targeting of users in the network.

In a representative embodiment, the method further comprises the steps of associating an activation status with said geographical zone and providing said customized information in accordance with said activation status.

Said activation status may be a status value that designates when the geographical zone is active and when it is inactive. Said activation status may be set by a user and/or by a provider of the network service.

In a representative embodiment, the method further comprises the steps of determining a position of said user relative to said geographical zone, and providing said customized information in accordance with said position.

A representative embodiment provides the user with customized information relating to said geographical zone when the user is found to be located within the geographical zone, or in the vicinity of said geographical zone. Said vicinity may be defined in terms of a predetermined distance to a selected point of interest in said geographical zone, or to a boundary of said geographical zone. For instance, a user may be provided with customized information whenever the user enters said geographical zone.

In a representative embodiment, the method further comprises the steps of receiving from a customized information provider geographical data and/or content information, comparing said geographical data and/or content information with data relating to said geographical zone and/or said interest data, respectively, and providing said content information to said user if said geographical data and/or content information matches said data relating to said geographical zone and/or interest data, respectively.

The customized information provider may be any third party that has an interest in providing said user with customized information. The customized information provider may be connected to the user via the network, or may be connected to the user indirectly via the network provider. The customized information provider may provide some geographical data relating to a geographical zone or area for which the customized information provider may want to provide users of the network with content information, and may further provide the associated content information. Said content information may comprise any information or data that the customized information provider may want to distribute, or any data information that the user may want to receive as customized information.

Said geographical data and/or content information may then be compared with the geographical zones and/or interest data provided by the user in order to determine, based on the matches, which user shall be provided with customized information, and what type of information shall be distributed.

In a representative embodiment, the method comprises the steps of receiving from a customized information provider geographical data and/or content information and/or temporal provider data, comparing said geographical data and/or content information with said geographical zone and/or said interest data and/or said temporal user data, respectively, and providing said content information to said user if said geographical data and/or said content information and/or said temporal provider data matches said geographical zone and/or said interest data and/or said temporal user data, respectively.

The customized information provider may provide temporal provider data specifying at which times customized information shall be provided to the users in the network. Said temporal provider data may be compared with temporal user data indicating at which times a user may be interested in receiving customized information.

The matching between information and data provided by the user and information and data provided by the customized information provider may take place at a central location separate from the customized information provider, such as at the server managing the network system. This may help to ensure that confidential information relating to said geographical zone and/or said interest data specified by said user is not revealed to said customized information provider.

Alternatively, the method according to the present disclosure may likewise comprise a step of providing said geographical zone and/or said interest information to a customized information provider.

This may allow the customized information provider to improve the quality of the targeting.

In a representative embodiment, the method further comprises a step of providing to a customized information provider a billing cost entry associated with providing said customized information to said user. This may allow the network service provider to charge the customized information provider for being able to provide customized information to a user.

The method may further comprise a step of renting or auctioning a location in said geographical zone to a customized information provider.

Said customized information may be promotional information and/or advertisement information.

Said customized information may comprise a location in said geographical zone, said location being provided by a customized information provider. The location may be a location at which the customized information provider may want to place an advertisement, alert, or some other kind of information in the user's map.

In a representative embodiment, the method further comprises the steps of providing geographical area data to said user over said network, receiving from said user said data relating to said geographical zone, and receiving from said user said interest data relating to said geographical zone. Said geographical zone may be defined or selected by said user from said geographical area data.

This allows said user to define or select said geographical zone from among geographical area data provided over said network. Said geographical area data may be provided to the user in terms of a map or a set of maps, or in terms of a description of a geographical area provided to the user. Said geographical zone may be a subset or a plurality of subsets of said geographical area, or any description of said subset/subsets. The user may define said geographical zone by outlining an arbitrary region on a touchscreen, by providing geographical coordinates of the zone, or by providing any other suitable description of the zone.

In a representative embodiment, said geographical zone may be defined by at least one circle and/or by at least one polygon. Said geographical zone may, in general, be defined as an interior or exterior of a boundary line, which may be any straight or curved line.

Said geographical zone may also be a street or a plurality of streets, possibly including their vicinity. Said vicinity may comprise a predefined zone or area adjoining said street(s), or extending along said street(s).

Said geographical zone may also be a predefined quarter or neighborhood, either in the real world or in a virtual world.

Said geographical zone may comprise a plurality of separate sub-zones. Said sub-zones may not be directly connected.

The present disclosure includes a method for providing customized information in a network, said method comprising the steps of receiving geographical area data from a server in said network, and associating content information with said geographical area data, said content information to be provided to a user over said network. In particular, said content information may be provided to said user via said server.

Said server may be any server to which users are connected via said network.

In a representative embodiment, said geographical area data comprises a geographical zone selected and/or defined by said user.

Said method may further comprise a step of receiving interest data from said server, said interest data selected and/or defined by said user.

In a representative embodiment, the method further comprises a step of comparing said interest data with said content information. Content information may be provided to said user if said content information matches said interest data.

Said geographical area data may be any data relating to a geographic region in the real world or in a virtual world, as described above. In particular, said geographical area data may comprise a map or a set of maps or a description of a geographical area provided to said customized information provider. Said geographical area data may relate to a geographical extension of said network, and/or may relate to geographical zones defined or selected by a single user or a plurality of users connected via said network.

In a representative embodiment, said method further comprises the steps of receiving temporal user data from said server, and associating said content information with said temporal user data. Said temporal user data may be data selected or defined by said user.

By incorporating temporal user data provided from said server, users may be provided with content information in accordance with their time preferences. This allows improved targeting.

The disclosure further relates to a server system for providing customized information to a user in a network, said system comprising means for associating interest data with data relating to a geographical zone, said geographical zone and/or said interest data defined or selected by said user, means for associating customized information with said interest data and/or said geographical zone, as well as means for providing said customized information to said user.

In a representative embodiment, the server system further comprises means for associating said geographical zone and/or said interest data with temporal user data, as well as means for associating said customized information with the temporal user data. Said temporal user data may be defined or selected by said user.

In a representative embodiment, the server system further comprises means for receiving from a customized information provider geographical data and/or content information, as well as means for comparing said geographical data and/or content information with said geographical zone and/or said interest data, respectively, and means for providing said content information to said user if said geographical data and/or content information matches said geographical zone and/or interest data, respectively.

The disclosure further relates to a system for providing customized information to a server in a network, said system comprising means for receiving geographical area data from said server, as well as means for associating content information with said geographical area data, said content information to be provided to a user over said network.

The disclosure likewise relates to a computer-program product for storing computer-readable instructions, such that said computer-program product, when read on said computer, implements a method with some or all of the features as described above.

### DESCRIPTION OF THE DRAWINGS

The features and numerous advantages of the present disclosure will be best understood from a detailed description of the representative embodiments in conjunction with the accompanying drawings, in which,

FIG. 1 illustrates a user-defined geographical zone according to an embodiment of the present disclosure;

FIG. 2 illustrates an input mask allowing a customized information provider to select among categories of customized information to be provided to a user;

FIG. 3 illustrates how a customized information provider may analyze user zones to select a location for placing an advertisement in a map;

FIG. 4 illustrates how a user may request recommendations for featured geographical zones according to an embodiment of the present disclosure; and

FIG. 5 schematically illustrates how the current disclosure may be implemented on a mobile phone.

### DETAILED DESCRIPTION

Various embodiments of the present disclosure will now be described, including the specific example of a method for placing advertisements in a social network environment in which the user may define geographical zones associated with interest data.

Specific embodiments of how users may define zones and maps in a network environment are described in U.S. patent application Ser. No. 13/763,566, entitled “Method and System for Associating User Interests with Zones and Maps,” filed Feb. 8, 2013, which claims the benefit of U.S. Provisional Patent Application No. 61/599,915, filed Feb. 16, 2012, the disclosures of which are hereby incorporated by reference in their entirety.

(i) Establishment of Maps and Zones

The user-defined zones may represent areas in the real world, such as parts of a city, or in a virtual world, such as in the setting of a network computer game.

The user may associate a special interest with the map or zone, and may further associate said special interest with a particular time parameter. The interest(s) attached to a zone may be a single interest, a plurality of interests, or an interest tree comprising a hierarchical structure of interests. The interests may be interests that are shared by some or all members of a social network or may be individual interests of that specific user.

The user may select said geographical zones in order to establish correlations with other users in the network, or to receive updates on services and activities pertaining to said geographical zones. Said geographical zones may thus allow better targeting for location-based services.

Optionally, geographical zones may be active for a certain predetermined time span only. For instance, the user may select the time setting such that a given zone is active at regular intervals, such as every day from 1 p.m. to 5 p.m., only on Sundays, only from December to March, daily from 6 p.m. to 12 p.m., etc. Alternatively, the user may specify that a defined zone is active only once, such as on a predefined day or during a predefined week of the year.

Zones can be defined in any shape. For instance, zones may be circles with a predefined radius around a predefined center. Zones can likewise be formed as a rectangle or a multi-edged polygon, or in any other shape, both with straight and curved boundary lines. A user may be allowed to add to or amend a previously defined zone at a later stage so as to transform it into the desired shape. The user may likewise add or delete further zones.

The user may be connected to a server and/or to other users via a network such as the Internet, or a part of the Internet establishing a closed or open social network. The server may be any conventional server or network computer. The user may employ any conventional client computer, such as a desktop computer or mobile computer, or any other computing and/or communication device, such as a mobile phone, a smart phone, or a tablet computer.

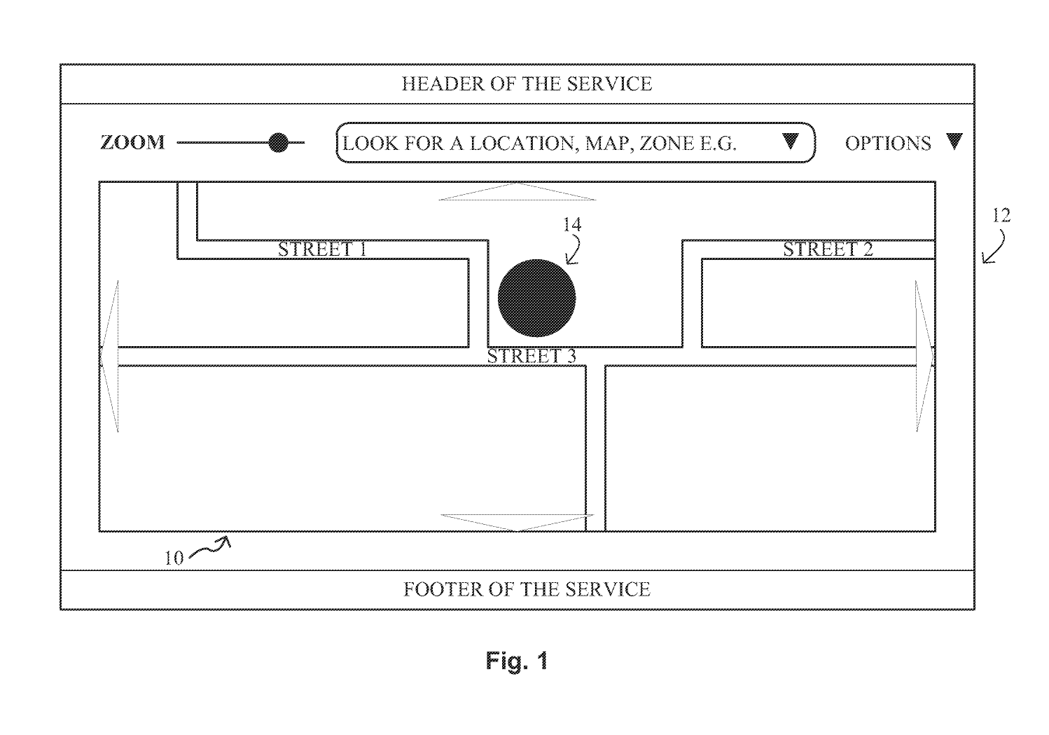

The server may provide the user with geographical area information such as a geographical map 10 or set of maps, which may be displayed on a display 12 such as a tablet display or mobile phone display, as shown in FIG. 1. In the example shown in FIG. 1, the map 10 comprises a neighborhood or a plurality of streets in a city. However, any geographical map may be used. The visible indicator of a user-defined geographical zone 14 is shaded in black in FIG. 1.

The user-defined geographical zone 14 may be defined by outlining an arbitrary region on the map 10, either in a free-hand fashion or by selecting among a plurality of predefined shapes, such as circles, rectangles, and multi-edged polygonal shapes.

A navigation tool may allow the user to zoom in and out of the map. The display likewise provides a search mask that allows the user to search a location in the map and/or in said user-defined zone. A graphical icon indicates a selected location on the map. This may be the current position of the user. Geographical coordinates of the user may, for instance, be obtained by employing a GPS system or any other kind of localization system, as conventionally implemented in many mobile communication and computing devices. However, the graphical icon may likewise denote some other predefined or selected location unrelated to the present location of the user.

The map displayed in FIG. 1 may comprise a further icon that allows a user to create a new geographical zone at a specified location. The user may move the icon anywhere on the map 10 and may then click on the map 10 to open a menu, where the user can either create a new zone or, alternatively, apply an existing zone to a new additional location.

The user may specify a number of parameters in order to define a new zone. For instance, the user may designate a name or title for the new zone. The user may also define the size of the zone. For instance, the zone may be defined in terms of a radius, such as a 1 kilometer radius, around a selected location on the map 10. The radius may be selected from among a predefined choice of radius values, or may be defined by the user.

The user may designate at least one interest connected to the newly defined zone. This may be achieved by setting relevant filter values or by finding relevant interests. The user may define one or more interests for the zone. The user may select from a list of interests, which may be based on former input by the same user or based on recommendations provided by the server. Interests may relate to sports, restaurants, shopping, or any other kind of interests the user may want to associate with the new geographical zone.

The user may also decide when the newly defined zone should be used, for instance, by designating the times when the zone should be active, and whether and when the zone should be used in combination with the user position.

Certain geographical zones may be interesting for the user only at certain predefined times. This may be on a daily, weekly, monthly, or other regular basis. For instance, if the zone is the user's home-zone and the user has designated an interest in food, the user may select respective time windows when to be informed with restaurant updates, such as around noon and in the evening. However, the user may also specify zones that do not repeat on a regular basis and are active only at a designated time, for instance, for the duration of a particular weekend or week. This may be useful if the user is on vacation, and the zone is a designated zone around his hotel.

The zone may be selected to be active based on presence in the zone (e.g., only in connection with the user's presence in the zone). For instance, the position of the user may be tracked, and the zone may be activated only if a user approaches a boundary of the zone, enters the zone, or is detected within the zone. Alternatively, the zone may be activated if the user is not in the zone so that the user may receive updates while being away from the zone. The zone might also be activated based on whether predefined other users are present in the zone, so that the user may be informed about the location of a friend or acquaintance in the zone.

The user may further define points of interest in the zone, such as restaurants or shops in which the user takes a particular interest. A zone need not necessarily be simply a geographically continuous area, but may likewise be a combination of a plurality of sub-zones or locations. For instance, a zone can be defined as the plurality of all locations of a specific restaurant type or restaurant chain. As an example, five separate locations of such restaurants may be combined into a common zone.

To add another location to a zone, the user can either mark it on the map 10 or may specify the location by selecting the location from a list that may be provided by the server or may be pre-prepared by the user.

In general, any user may define a plurality of different zones. When employed in a network setting, the system according to the present disclosure may be adapted to display, on the user's computer display 12, zones defined by selected other users in the network, such as friends or acquaintances. All these further users may define their zones locally on their computer device. This information will then be provided to the central server and can be distributed from there within the network. A user interface element (e.g., a button or drop-down menu) called “options” may allow the user to access a filter specifying which of the zones should be displayed. For instance, the user may choose to display only his own zones or may choose to display some or all of the zones of selected other users of the network. The user may, likewise, copy a zone of another user to his own zones. The user may also share and recommend a zone to other users.

A user that receives a recommendation of a zone from another user can be provided with an icon designating information about the recommended zone, such as the number of locations in said zone or the geographical extension of said recommended zone.

At least one embodiment of the present disclosure is particularly effective when the client system is adapted to display a graphical view of the geographical area information provided from the server and of the geographical zones selected by the user. However, the disclosure is not so limited and may also be employed if the client's system does not support a map-based view. In this case, the user may define a geographical zone by providing a description of said zone, for instance, by providing an address and specifying a circle of a predetermined radius around said location. Recommendations based on the interests defined by the user may then be displayed at the client's system as a list of recommendations. This list may be filtered by enabling and disabling the user zones.

(ii) Providing Customized Information

The user-defined zones may allow an advertiser to provide customized advertisements or promotions to said user. The advertiser may select an advertisement in accordance with geographical data and the interest data specified by the user, which allows for customized or targeted advertising.

Advertisers may define when and where a specific advertisement is displayed on a geographical display employed by a user. In particular, advertisers may specify in which geographical zone defined by a user an advertisement may be displayed, or at what times and for how long.

The advertisement may be displayed in accordance with an activation status of said geographical zone. For instance, the geographical zone may be activated only if the user is currently located inside the geographical zone.

The advertisement may be tailored to the interest data associated with that particular zone. For instance, an advertisement may be displayed only if the interests associated with this particular zone match a set of conditions defined by the advertiser. In particular, an advertisement may be displayed if the advertisement falls into a category registered as an interest for that user and that geographical zone, such as shopping, food, or sports.

The comparison of the advertisement information with the user-defined interests may take place at the server location. Alternatively, the interest data relating to a user or a group of users may be provided to the advertiser so that the comparison may be performed at the location of the advertiser. The advertiser may either be part of said network, or may be connected to said network via said server.

Based on a systematic analysis of user interests and matching with the advertisement targeting data, an advertiser may request meaningful locations that may be added to the targeting. The analysis may take into account demographical and personal data of the users as well as statistical information related to the network, such as the relative frequency with which a specific geographical zone or location inside said zone is visited by users of the network.

At least one embodiment of the present disclosure allows the provider of the social network to rent or auction virtual advertisement space related to user zones. Renting “virtual real estate” can be exclusive to one user or advertiser or may be non-exclusive in order to allow different advertisers to use the same advertising space for different targeting. The rules for renting may be set by the provider of the social network. Renting can be limited in time. Depending on the settings chosen by the provider, the rent or minimum bid may depend on the demand, on the number of geographical zones comprising a specific advertisement location, or on the relative frequency with which said zones or said location are visited by the users.

As an aspect of the present disclosure, users may be offered special bargains and deals. For instance, a user that follows a link provided by the advertiser in the geographical zone of that user may get a ten percent discount on his purchases.

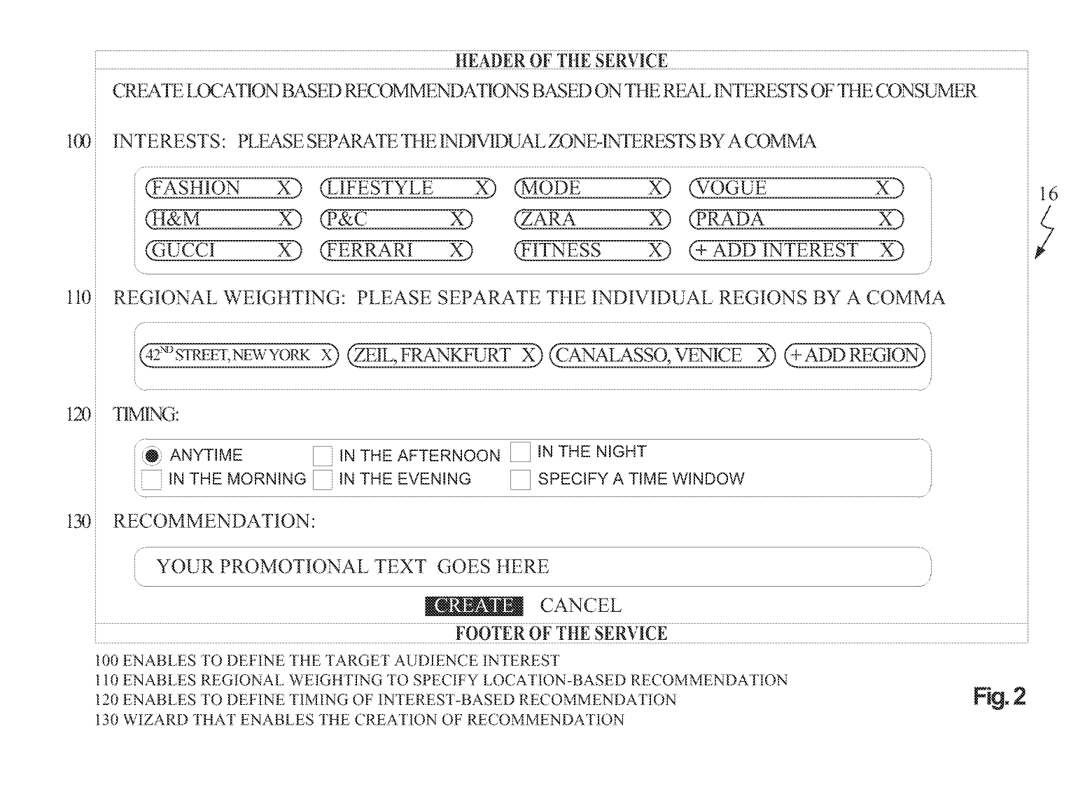

FIG. 2 illustrates an input mask 16 that an advertiser may employ to select categories for which the advertiser would like to provide advertisements and which the advertiser would like to have compared against the user's designated interests 100. Categories may include fashion, fitness, lifestyle or any other categories into which advertisements may commonly be classified. Categories may be chosen from a list of predefined categories, as illustrated in FIG. 2, but may likewise be defined or entered freely by the advertiser.

The advertiser may further define at which location an advertisement shall be displayed (see “Regional Weighting” section 110). The examples illustrated in FIG. 2 refer to real-world locations. However, the locations may also refer to virtual locations, such as locations in the setting of a network computer game.

The advertiser may further define at what time(s) the advertisement shall be displayed, for instance by specifying time periods or time cycles (see “Timing” section 120). Finally, the advertiser may also define the content of the advertisement (see “Recommendation” section 130). The advertiser may add an image, a video, a promotional text, animations, etc., for display in the map of the user at the selected location.

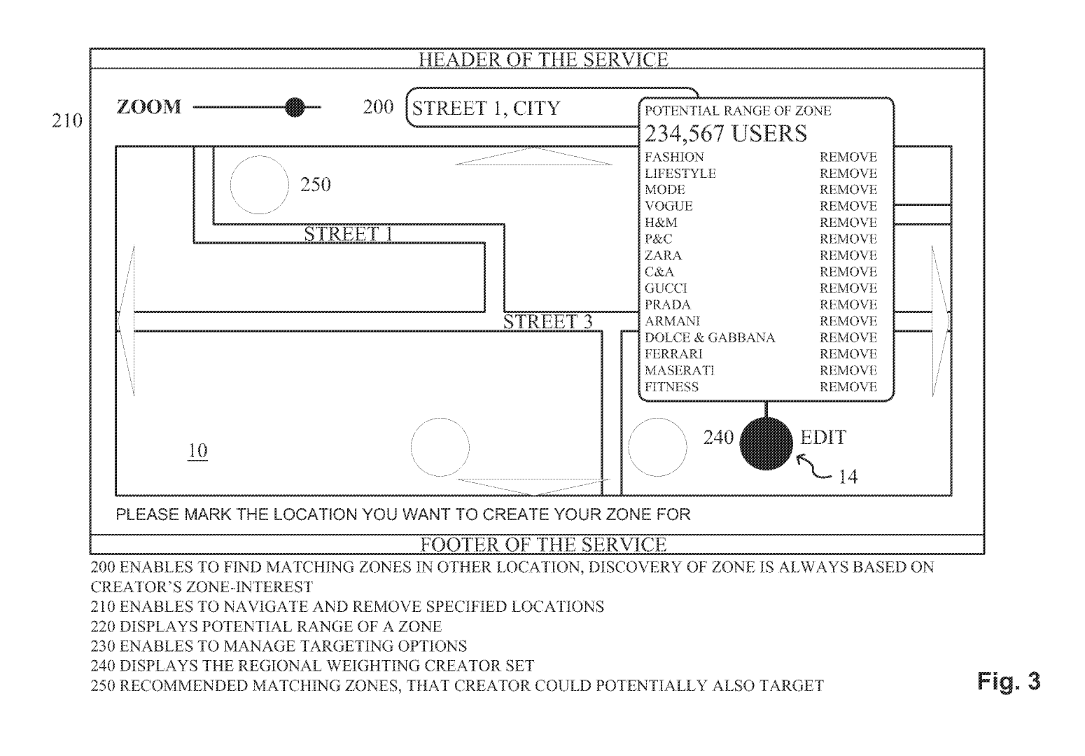

As illustrated in FIG. 3, the advertiser may analyze the geographical zones defined by the users and the associated interests to optimize the positioning of advertisements. The advertiser may specify a location for advertisement display (see user interface element 200). The advertiser may also view all the locations presently connected to the advertiser's advertisements (see interactive map section 210), delete them, or click on them to jump to that specific location. Each displayed zone may be associated with a value or factor associated with the number of users that include the selected location into one of their geographical zones with a relevant interest (see user interface element 220, which includes an approximate number of users in the zone). The advertiser may edit and adapt the interests of the user to improve the targeting (see the editable list of interests 230 in the user interface element 220).

The network provider may analyze the geographical zones defined in the geographical area in which the advertiser has expressed an interest and may suggest to the advertiser all those zones 250 that match the set of criteria specified by the advertiser, as described above with reference to FIG. 2.

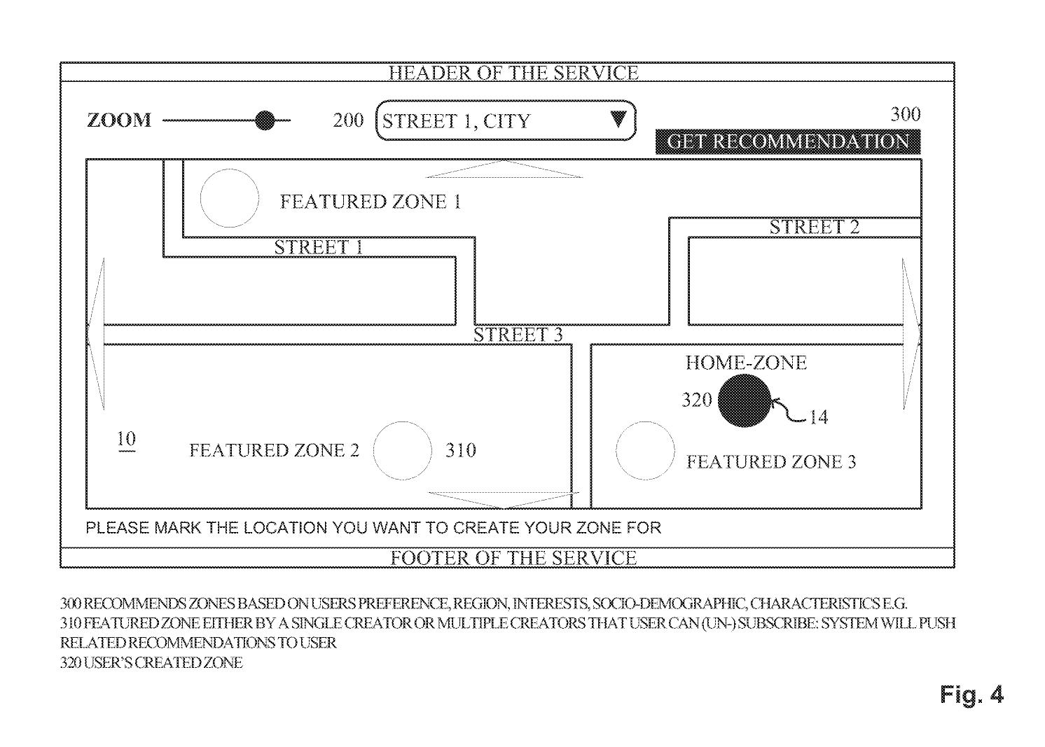

As illustrated in FIG. 4, the user may request recommendations for featured zones (see user interface element 300). These recommendations may be based on the user interests and the interests set for the featured zones. Recommendations may also take into account the geographical area associated with the featured zone as well as socio-demographic characteristics associated with that zone.

Featured zones 310 may be displayed with the corresponding name or a name of another user responsible for that zone. The geographical zones 320 defined by the user are likewise displayed on the map.

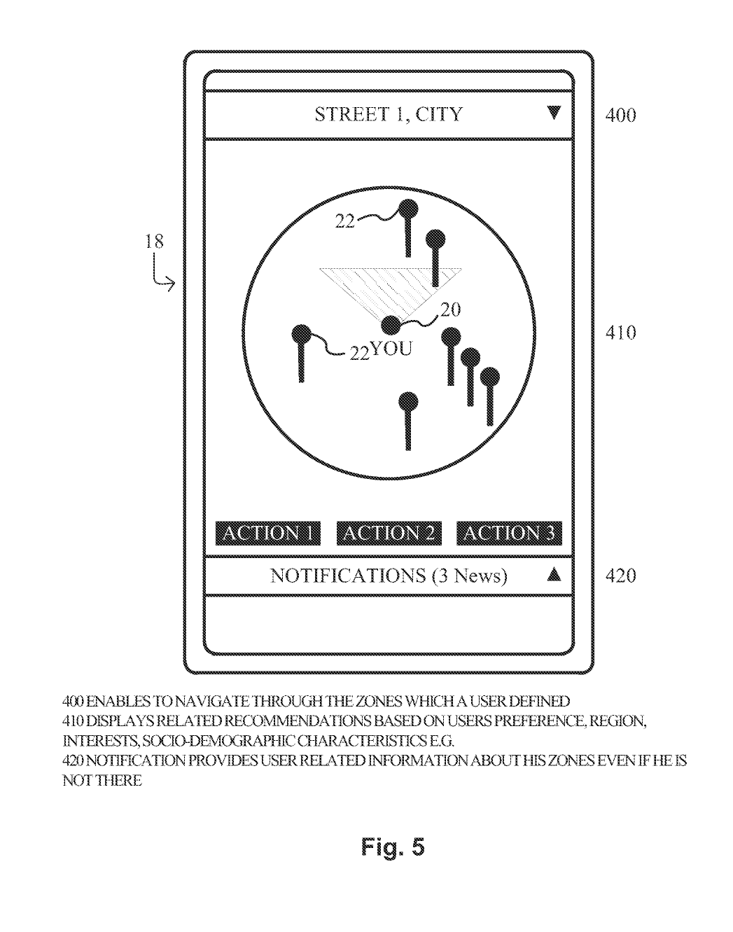

An example of an implementation on a mobile telephone device 18 is illustrated in FIG. 5. The user has activated the GPS functionality on his mobile device 18, and can see on the display his own current location 20 together with recommended zones or featured zones 22 in his immediate vicinity. The application shows that the user is currently located in zone 1 (“Street 1, City”) (see user interface element 400). This zone may be a zone created by the user, and is associated with specific interests of the user. If these interests match a certain advertisement, related recommendations are provided to the user. These recommendations are displayed as “action 1,” “action 2,” and “action 3” on the display of the mobile phone 18 (see user interface element 410).

The system may also inform the user of updates or notifications related to one or several other of his geographical zones (see user interface element 420).

The description of the representative embodiments and the accompanying drawings merely serve to illustrate the invention and the beneficial effects associated therewith, but should not be understood to imply any limitation on the scope of the claimed subject matter.

### REFERENCE SIGNS

10 geographical map

12 computer display

14 user-defined geographical zone

16 advertiser input mask

18 mobile phone

22 current user position

22 featured zones

100 option to select target audience interest

110 option for regional weighting to specify location-based recommendation

120 option to define timing of interest-based recommendation

130 wizard that enables the creation of the recommendation

200 option for finding matching zones in other location

210 option to navigate and remove specified locations

220 display of potential range of a zone

230 option to manage targeting options

240 displays the regional weighting creator set

250 recommended matching zones that creator could potentially also target

300 recommends zones, based on user's preference, region, interests, socio-demographic characteristics, etc.

310 name of featured zone

320 user's created zone

400 option for navigating through the user-defined zones

410 display of related recommendations, based on user's preference, region, interest, socio-demographic characteristics, etc.

420 notification that provides user related information about his zones

The embodiments of the invention in which an exclusive property or privilege is claimed are defined as follows:

1. A method for providing customized information to a user in a network, said method comprising the steps of:
associating interest data with a geographical zone, said geographical zone and/or said interest data defined or selected by said user;
associating customized information with said interest data and/or said geographical zone; and
providing said customized information to said user.

2. The method according to claim 1, further comprising the steps of:
associating said geographical zone and/or said interest data with temporal user data, said temporal user data defined or selected by said user; and
associating said customized information with said temporal user data.

3. The method according to claim 2, further comprising the steps of:
receiving from a customized information provider geographical data and/or content information and/or temporal provider data;
comparing said geographical data and/or content information and/or temporal provider data with said geographical zone and/or said interest data and/or said temporal user data, respectively; and
providing said content information to said user if said geographical data and/or said content information and/or said temporal provider data matches said geographical zone and/or said interest data and/or said temporal user data, respectively.

4. The method according to claim 1, further comprising the steps of:
associating an activation status with said geographical zone; and
providing said customized information in accordance with said activation status.

5. The method according to claim 1, further comprising the steps of:
determining a position of said user relative to said geographical zone; and
providing said customized information in accordance with said position.

6. The method according to claim 1, further comprising the steps of:
receiving from a customized information provider geographical data and/or content information;
comparing said geographical data and/or content information with said geographical zone and/or said interest data, respectively; and
providing said content information to said user if said geographical data and/or said content information matches said geographical zone and/or said interest data, respectively.

7. The method according to claim 1, further comprising a step of providing said geographical zone and/or said interest data to a customized information provider.

8. The method according to claim 1, further comprising a step of providing to a customized information provider a billing cost entry associated with the providing of said customized information to said user.

9. The method according to claim 1, further comprising a step of renting or auctioning a location in said geographical zone to a customized information provider.

10. The method according to claim 1, wherein said customized information comprises a location in said geographical zone, said location being provided by a customized information provider.

11. A method for providing customized information in a network, said method comprising the steps of:
receiving geographical area data from a server in said network; and
associating content information with said geographical area data, said content information to be provided to a user over said network.

12. The method according to claim 11, wherein said geographical area data comprises a geographical zone selected and/or defined by said user.

13. The method according to claim 11, further comprising a step of receiving interest data from said server, said interest data selected and/or defined by said user.

14. The method according to claim 13, further comprising a step of comparing said interest data with said content information.

15. The method according to claim 11, further comprising the steps of:
receiving temporal user data from said server; and
associating said content information with said temporal user data.

16. A server system for providing customized information to a user in a network, said system comprising:
means for associating interest data with a geographical zone, said geographical zone and/or said interest data defined or selected by said user;
means for associating customized information with said interest data and/or said geographical zone; and
means for providing said customized information to said user.

17. The server system according to claim 16, further comprising:
means for associating said geographical zone and/or said interest data with temporal user data, said temporal user data defined or selected by said user; and
means for associating said customized information with said temporal user data.

18. The server system according to claim 16, further comprising:
means for receiving from a customized information provider geographical data and/or content information;
means for comparing said geographical data and/or content information with said geographical zone and/or said interest data, respectively; and
means for providing said content information to said user if said geographical data and/or content information matches said geographical zone and/or interest data, respectively.

19. The server system according to claim 16, wherein the server system is connected to a provider system for providing customized information to the server system via a network, said provider system comprising:
means for receiving geographical area data from said server system; and
means for associating content information with said geographical area data, said content information to be provided to a user over said network.
